(19) United States
(12) Patent Application Publication
(10) Pub. No.: US 2020/0110478 A1
(43) Pub. Date: Apr. 9, 2020

(54) TOUCH DEVICE

(71) Applicants: Interface Technology (ChengDu) Co., Ltd., Sichuan (CN); Interface Optoelectronics (ShenZhen) Co., Ltd., Guangdong (CN); General Interface Solution Limited, Miaoli County (TW)

(72) Inventors: Teng-Chi CHANG, Guangdong (CN); Ching-Lin LI, Guangdong (CN); Yen-Heng HUANG, Guangdong (CN)

(21) Appl. No.: 16/195,839

(22) Filed: Nov. 19, 2018

(30) Foreign Application Priority Data
Oct. 8, 2018 (CN) 201811168128.3

(51) Int. Cl. G06F 3/041

(52) U.S. Cl. CPC G06F 3/041; A63F 13/24

(57) ABSTRACT

A touch device includes a sensor, an insulating board, and a button pattern region. The sensor has a touch sensing region. The insulating board covers the sensor. The button pattern region is located on a front side of the insulating board. The button pattern region is aligned with the touch sensing region.

### CROSS-REFERENCE TO RELATED APPLICATION

This application claims priority to China Application Serial Number 201811168128.3, filed Oct. 8, 2018, which is herein incorporated by reference in its entirety.

### BACKGROUND

### Field of Invention

The present disclosure relates to a touch device, and more particularly to a touch device combined with various insulating boards and sensors.

### Description of Related Art

With the development of technology, various remote controls of electronic devices, such as TV remote controls, home appliance remote controls, are frequently used in our daily life. However, different electronic devices usually correspond to different remote controls. One single remote control cannot respond to different types of electronic devices, thereby causing lots of inconvenience to the users.

On the other hand, as people's living level is getting higher, game devices also flourished. Through the development of game manufacturers, a wide variety of game devices are approached. However, different game devices require different game joysticks for operation, and a user cannot use one single game joystick to control different game devices. Therefore, universal remote controls and joysticks are restricted by design limits. Due to the function of products, different products need to be matched with different remote controls or joysticks, and thus the remote controls or joysticks of certain products cannot be applied to other products.

### SUMMARY

The disclosure provides a touch device, and more particularly provides a touch device combined with various insulating boards and sensors to solve the above problems.

According to some embodiments of the present disclosure, a touch device includes a sensor, an insulating board, and a button pattern region. The sensor has a touch sensing region. The insulating board covers the sensor. The button pattern region is located on a front side of the insulating board. The button pattern region is aligned with the touch sensing region.

According to some embodiments of the present disclosure, a rear surface of the insulating board has a recognition area.

According to some embodiments of the present disclosure, the sensor has a sensing area.

According to some embodiments of the present disclosure, the recognition area is in contact with the sensing area.

According to some embodiments of the present disclosure, the insulating board has a touch active region and a touch inactive region.

According to some embodiments of the present disclosure, the button pattern region is disposed in the touch active region and the recognition area is disposed on a rear surface of the touch inactive region.

According to some embodiments of the present disclosure, at least one conductive material is disposed in the recognition area.

According to some embodiments of the present disclosure, the insulating board is a bendable cardboard.

According some embodiments of the present disclosure, the insulating board is bent to contact four faces of the sensor.

According to some embodiments of the present disclosure, the insulating board is bent to contact six faces of the sensor.

In summary, a touch device includes a sensor, an insulating board, a button pattern region, and a touch sensing region. The touch device can be combined with various insulating boards and the sensors. By using this touch device, the single touch device can control different electronic products, thus improving convenience and providing better experience for users.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows.

FIGS. 1A and 1B are schematic views showing an insulating board in accordance with one embodiment of the present disclosure.

FIG. 2 is a schematic view of a sensor in accordance with one embodiment of the present disclosure.

FIG. 3 is a schematic view of a touch device in accordance with one embodiment of the present disclosure.

FIGS. 4A and 4B are schematic views showing an insulating board in accordance with another embodiment of the present disclosure.

FIG. 5 is a schematic view of a sensor in accordance with another embodiment of the present disclosure.

FIG. 6 is a schematic view of a touch device in accordance with another embodiment of the present disclosure.

FIG. 7 is a schematic view of a touch device in accordance with another embodiment of the present disclosure.

FIG. 8 is a schematic view of a touch device in accordance with another embodiment of the present disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

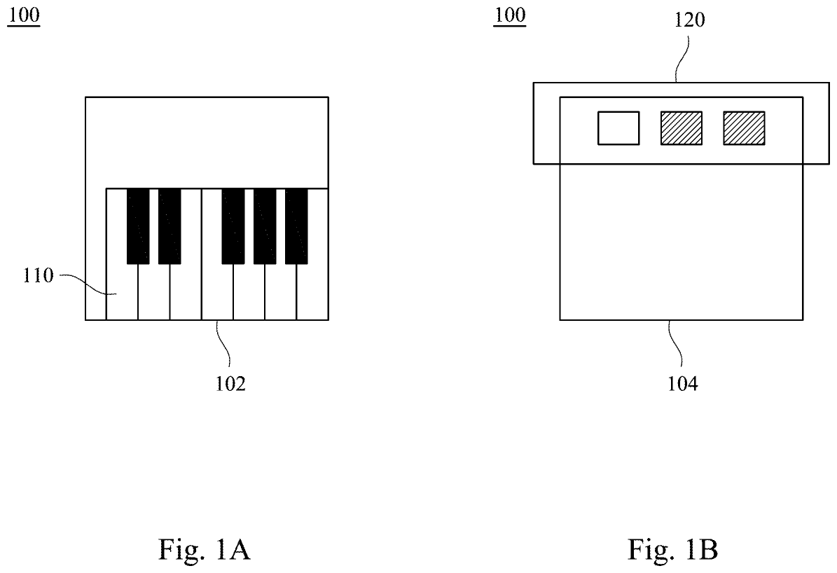

FIGS. 1A and 1B are schematic views showing an insulating board 100 in accordance with one embodiment of the present disclosure. Referring to FIG. 1A, FIG. 1A is a schematic view of a front surface 102 of the insulating board 100. A button pattern region 110 is disposed in the front surface 102. In the present embodiment, the button pattern region 110 may be a piano-keyboard pattern, but the disclosure is not limited thereto. The button pattern region 110 may be various patterns, characters or other visual information to meet users' actual requirements. In some embodiments, the button pattern region 110 may be formed on the insulating board 100 by printing, painting, photocopying, or the like. In some embodiments, the insulating board 100 may be made of paper, cardboard, or any other suitable insulating material. As shown in FIG. 1B, the rear surface 104 of the insulating board 100 has a recognition area 120, and at least one conductive material is disposed in the recognition area 120. For example, the recognition area 120 may include three recognition elements, in which two of the recognition elements have conductive materials, and the remaining recognition element does not have the conductive material.

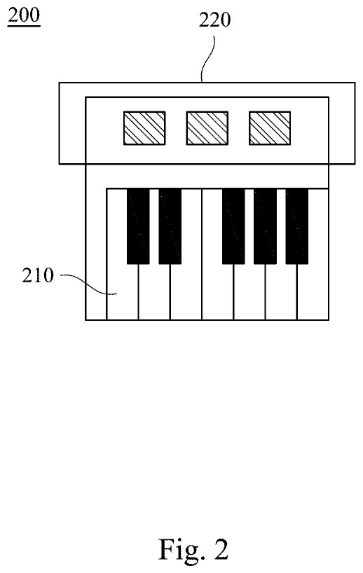

Referring to FIG. 2, FIG. 2 is a schematic view of a sensor 200 in accordance with one embodiment of the present disclosure. The sensor 200 has a touch sensing region 210 and a sensing area 220, and the touch sensing region 210 is located at a position relative to the button pattern region 110 of the insulating board 100 in FIG. 1A. In other words, when the insulating board 100 (as shown in FIG. 1A) covers the sensor 200, the button pattern region 110 (as shown in FIG. 1A) is aligned with the touch sensing region 210. For example, the button pattern region 110 (as shown in FIG. 1A) is directly located, on the touch sensing region 210 by, for example, adhesion or gluing. The sensing area 220 includes at least one sensing element corresponding to the recognition area 120 (as shown in FIG. 1B). In other words, the number of sensing elements in the sensing area 220 is the same as the number of recognition elements in the recognition area 120 (as shown in FIG. 1B). In the present embodiment, the sensing area 220 includes three sensing elements, and the recognition area 120 also includes three recognition elements, but the disclosure is not limited thereto. For example, the number of sensing elements in the sensing area 220 may be two, four, five, or more, and the number of the sensing elements in the recognition area 120 may be two, four, five, or more.

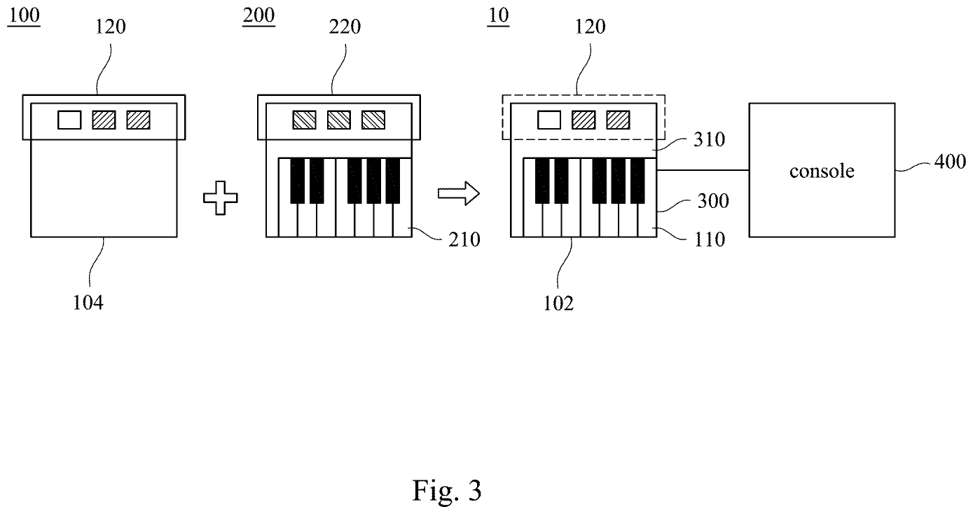

Referring to FIG. 3, FIG. 3 is a schematic view of a touch device 10 in accordance with one embodiment of the present disclosure. The insulating board 100 covers the sensor 200 to form the touch device 10. For example, the insulating board 100 may be attached, to and cover the sensor 200 by gluing, or any other suitable method, so as to form the touch device 10. In some embodiments, the thickness of the attached area between the insulating board 100 and the sensor 200 is less than or equal to 3 mm, so as to achieve better touch feedback. When the thickness of the attached area between the insulating board 100 and the sensor 200 is greater than 3 mm, the touch feedback is weaker and may result in an increase in power consumption or a decrease in touch precision. In the present embodiment, for convenience of explanation, a dashed line in FIG. 3 is used to illustrate the recognition area 120 located on the rear surface of the insulating board 100. In the present embodiment, the recognition area 120 located on the rear surface 104 of the insulating board 100 is attached to the sensing area 220 of the sensor 200, so as to match the recognition area 120 with the sensing area 220, and then a console 400 is used to recognize the match between the recognition area 120 with the sensing area 220 and activate a corresponding operation. In other words, the recognition area 120 may be aligned with and in contact with the sensing area 220. In greater detail, the conductive material included in the recognition area 120 of the insulating board 100 is used to contact the sensing area 220 of the sensor 200 for enabling the recognition area 120 to be matched with the sensing area 220, such that the console 400 may activate a corresponding program. For example, a set of identity (ID) numbers may be designed at the console 400. When the recognition area 120 is matched with the sensing area 220, the set of ID numbers is activated correspondingly, such that the console 400 may run the corresponding program with respect to the set of ID numbers. For example, the recognition element in the recognition area 120 is defined as “1” when the recognition element in contact with the conductive material, and is defined as “0” when the recognition element is not in contact with the conductive material. As shown in FIG. 3, the set of ID numbers of the touch device 10 is “011”, but the present disclosure is not limited thereto. The set of ID numbers of the touch device 10 may be “000”, “001”, “010”, “100”, “101”, “110”, and “111”. In the present embodiment, after the console 400 detects that the ID number is “011”, the button pattern region 110 on the touch device 10 is automatically activated, and the function of the piano keyboard is also activated.

Referring to FIG. 3, the touch device 10 has a touch active region 300 and a touch inactive region 310 relative to the touch active region 300. The touch active region 300 and the touch inactive region 310 are disposed in different regions of the touch device 10. In the present embodiment, the button pattern region 110 is located in the touch active region 300, and a user may perform operation in the touch active region 300. The recognition area 120 is located on a rear surface of the touch inactive region 310 which is illustrated as the dashed line in FIG. 3. In some embodiments, the connection between the console 400 and the touch device 10 may be a physical connection, for example, an electrical connector. The connection between the console 400 and the touch device 10 may also be a virtual connection, for example, an infrared connection, a Wi-Fi connection, or a Bluetooth connection.

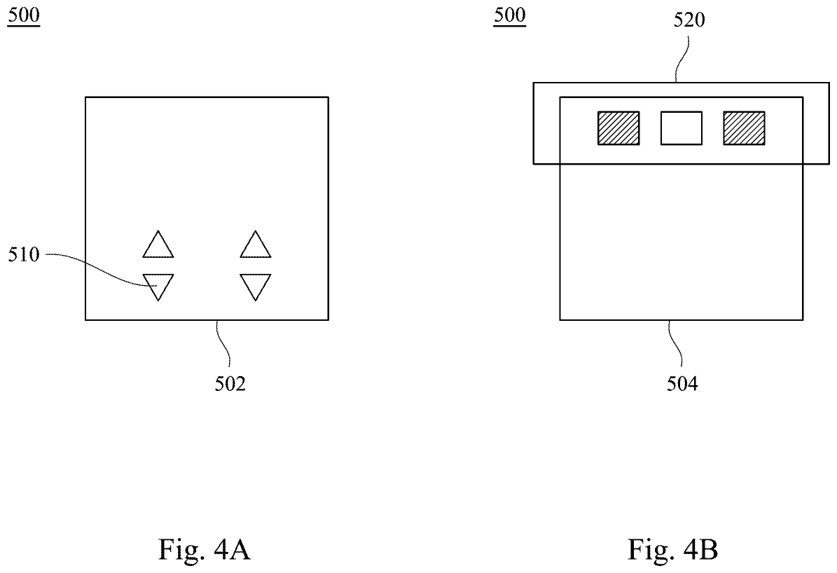

Referring to FIGS. 4A and 4B, FIGS. 4A and 4B are schematic views of an insulating board 500 in accordance with another embodiment of the present disclosure. Referring to FIG. 4A, FIG. 4A is a schematic view of a front surface 502 of the insulating board 500. A button pattern region 510 is disposed in the front surface 502. In the present embodiment, the button pattern region 510 may be a game joystick pattern, but the disclosure is not limited thereto. The button pattern region 510 may be various patterns, characters or other visual information to meet users' actual requirements. In some embodiments, the button pattern region 510 may be formed on the insulating board 500 by printing, painting, photocopying, or the like. In some embodiments, the insulating board 500 may be made of paper, cardboard, or any other suitable insulating material. As shown in FIG. 4B, the rear surface 504 of the insulating board 500 has a recognition area 520, and at least one conductive material is disposed in the recognition area 520. For example, the recognition area 520 may include three recognition elements, in which two of the recognition elements have conductive materials, and the remaining recognition element does not have the conductive material.

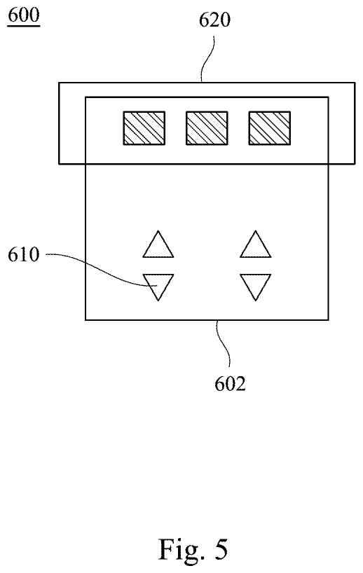

Referring to FIG. 5, FIG. 5 is a schematic view of a sensor 600 in accordance with one embodiment of the present disclosure. The sensor 600 has a touch sensing region 610 and a sensing area 620, and the touch sensing region 610 is located at a position relative to the button pattern region 510 of the insulating board 500 in FIG. 4A. In other words, when the insulating board 500 (as shown in FIG. 4A) covers the sensor 600, the button pattern region 510 (as shown in FIG. 4A) is aligned with the touch sensing region 610. For example, the button pattern region 510 (as shown in FIG. 4A) is directly located, on the touch sensing region 610 by, for example, adhesion or gluing. The sensing area 620 includes at least one sensing element corresponding to the recognition area 520 (as shown in FIG. 4B). In other words, the number of sensing elements in the sensing area 620 is the same as the number of recognition elements in the recognition area 520 (as shown in FIG. 4B). In the present embodiment, the sensing area 620 includes three sensing elements, and the recognition area 520 also includes three recognition elements, but the disclosure is not limited herein. For example, the number of sensing elements in the sensing area 620 may be two, four, five, or more, and the number of the sensing elements in the recognition area 520 may be two, four, five, or more.

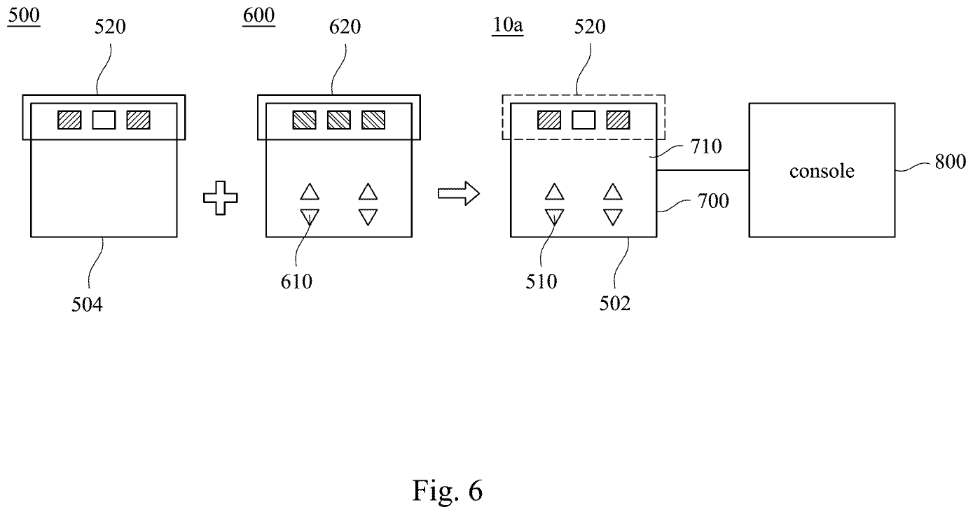

Referring to FIG. 6, FIG. 6 is a schematic view of a touch device 10a in accordance with another embodiment of the present disclosure. The insulating board 500 covers the sensor 600 to form the touch device 10a. For example, the insulating board 500 may be attached, to and cover the sensor 600 by gluing, or any other suitable method, so as to form the touch device 10a. In some embodiments, the thickness of the attached area between the insulating board 500 and the sensor 600 is less than or equal to 3 mm, so as to achieve better touch feedback. When the thickness of the attached area between the insulating board 500 and the sensor 600 is greater than 3 mm, the touch feedback is weaker and may result in an increase in power consumption or a decrease in touch precision. In the present embodiments, for convenience of explanation, a dashed line in FIG. 6 is used to illustrate the recognition area 520 located on the rear surface of the insulating board 500. In the present embodiment, the recognition area 520 located on the rear surface 504 of the insulating board 500 is attached to the sensing area 620 of the sensor 600, so as to match the recognition area 520 with the sensing area 620, and then a console 800 is used to recognize the match between the recognition area 520 with the sensing area 620 and activate a corresponding operation. In other words, the recognition area 520 may be aligned with and in contact with the sensing area 620. In greater detail, the conductive material included in the recognition area 520 of the insulating board 500 is used to contact the sensing area 620 of the sensor 600 for enabling the recognition area 520 to be matched with the sensing area 620, such that the console 800 may activate a corresponding program. For example, a set of ID numbers may be designed at the console 800. When the recognition area 520 is matched with the sensing area 620, the set of ID numbers is activated correspondingly, such that the console 800 may run the corresponding program with respect to the set of ID numbers. For example, the recognition element in the recognition area 520 is defined as “1” when the recognition element in contact with the conductive material, and is defined as “0” when the recognition element is not in contact with the conductive material. As shown in FIG. 6, the set of ID numbers of the touch device 10a is “101”, but the present disclosure is not limited thereto. The set of ID numbers of the touch device 10a may be “000”, “001”, “010”, “011”, “100”, “110”, and “111”. In the present embodiment, after the console 800 detects that the ID number is “101”, the button pattern region 510 on the touch device 10a is automatically activated, and the function of the game joystick is also activated.

Referring to FIG. 6, the touch device 10a has a touch active region 700 and a touch inactive region 710 relative to the touch active region 700. The touch active region 700 and the touch inactive region 710 are disposed in different regions of the touch device 10a. In the present embodiment, the button pattern region 510 is located in the touch active region 700, and a user may perform operation in the touch active region 700. The recognition area 520 is located on a rear surface of the touch inactive region 710 which is illustrated as the dashed line in FIG. 6. In some embodiments, the connection between the console 800 and the touch device 10a may be a physical connection, for example, an electrical connector. The connection between the console 800 and the touch device 10a may also be a virtual connection, for example, an infrared connection, a Wi-Fi connection, or a Bluetooth connection.

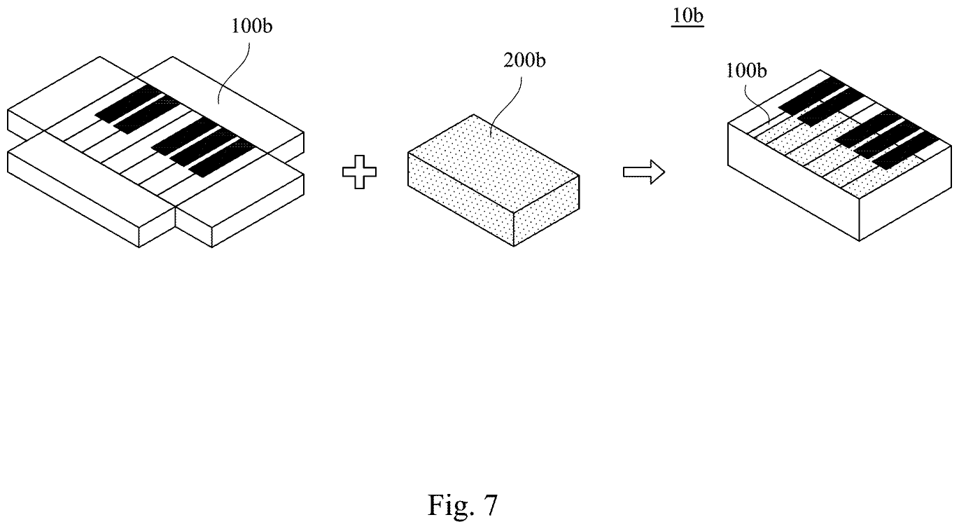

Referring to FIG. 7, FIG. 7 is a schematic view of a touch device 10b in accordance with another embodiment of the present disclosure. The main difference between the touch device 10b of the present embodiment and the touch device 10 (as shown in FIG. 3) is that the touch device 10b of the present embodiment includes a bendable insulating board 100b. In greater detail, the insulating board 100b is bent to contact the four faces of the sensor 200b to form the touch device 10b. For example, the insulating board 100b may be attached, to and cover the sensor 200b by gluing, or any other suitable method. In some embodiments, the insulating board 100b may be any polyhedral structure containing more than four faces. The sensor 200b is first attached to the insulating board 100b, and then assembled and bent to form the touch device 10b having a three-dimensional shape. In some embodiments, the insulating board 100b may be made of a bendable cardboard or other bendable insulating material.

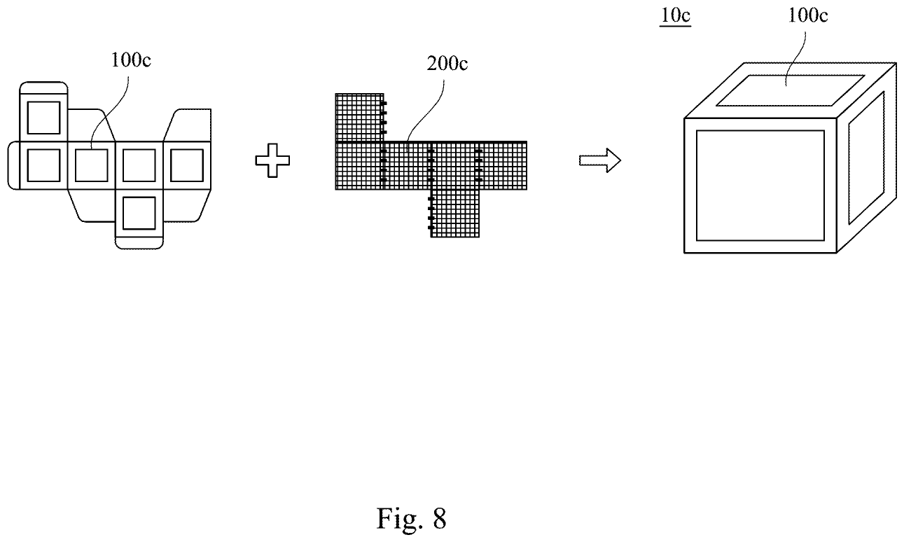

Referring to FIG. 8, FIG. 8 is a schematic view of a touch device 10c in accordance with another embodiment of the present disclosure. The main difference between the touch device 10c of the present embodiment and the touch device 10 (as shown in FIG. 3) is that the touch device 10c of the present embodiment includes a bendable hexahedral insulating board 100c. In greater detail, the hexahedral insulating board 100c is bent to contact the six faces of the sensor 200c to form the touch device 10c. For example, the insulating board 100c may be attached, to and cover the six faces of the sensor 200c by gluing, or any other suitable method. The sensor 200c is first attached to the insulating board 100c, and then assembled and bent to form the touch device 10c having a three-dimensional shape. In some embodiments, the six faces of the touch device 10c are all touch active regions, that is, the user may perform touch operation on the six faces of the touch device 10c. In some embodiments, the insulating board 100c may be made of a bendable cardboard or other bendable insulating material.

From the above detailed description of the embodiments of the present disclosure, it can be known that a touch device includes a sensor, an insulating board, a button pattern region, and a touch sensing region. The touch device can be combined with various insulating boards and the sensors. By using this touch device, one single touch device can control different electronic products, thus improving convenience and providing better experience for users.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A touch device, comprising:
a sensor having a touch sensing region;
an insulating board covering the sensor; and
a button pattern region disposed on a front surface of the insulating board, wherein the button pattern region is aligned with the touch sensing region.

2. The touch device of claim 1, wherein a rear surface of the insulating board has a recognition area.

3. The touch device of claim 2, wherein the sensor has a sensing area.

4. The touch device of claim 3, wherein the recognition area is in contact with the sensing area.

5. The touch device of claim 2, wherein the insulating board has a touch active region and a touch inactive region.

6. The touch device of claim 5, wherein the button pattern region is disposed in the touch active region and the recognition area is disposed on a rear surface of the touch inactive region.

7. The touch device of claim 2, wherein the recognition area comprises at least one conductive material.

8. The touch device of claim 1, wherein the insulating board is a bendable cardboard.

9. The touch device of claim 1, wherein the insulating board is bent to contact four faces of the sensor.

10. The touch device of claim 1, wherein the insulating board is bent to contact six faces of the sensor.
